(19) United States
(12) Patent Application Publication
(10) Pub. No.: US 2025/0086354 A1
(43) Pub. Date: Mar. 13, 2025

(54) PRODUCT DESIGN GENERATION ASSISTANCE DEVICE, PRODUCT DESIGN GENERATION ASSISTANCE METHOD, AND RECORDING MEDIUM HAVING PRODUCT DESIGN GENERATION ASSISTANCE PROGRAM STORED THEREON

(71) Applicant: NEC Corporation, Minato-ku, Tokyo (JP)

(72) Inventors: Hanae Shimomura, Tokyo (JP); Makoto TAKAMOTO, Tokyo (JP)

(73) Assignee: NEC Corporation, Minato-ku, Tokyo (JP)

(21) Appl. No.: 18/273,938

(22) PCT Filed: Mar. 31, 2021
(86) PCT No.: PCT/JP2021/013813

§ 371 Date: Jul. 24, 2023

(51) Int. Cl. G06F 30/23; G06F 30/12; G06F 119/20; G06T 7/00

(52) U.S. Cl. CPC G06F 30/23; G06F 30/12; G06T 7/0006; G06F 2119/20

(57) ABSTRACT

A product design generation assistance device is provided with: an acquisition unit which acquires an existing product image representing the design of an existing product; an identification unit which, on the basis of the existing product image, identifies a feature of a new product design that satisfies a condition regarding differences from the design of the existing product; and an output unit which outputs design information about the new product design on the basis of the feature regarding the new product design. Thus the product design generation assistance device assists in generating a product design that is relatively eye-catching as compared to the existing product.

### TECHNICAL FIELD

The present invention relates to a product design generation assistance device, a product design generation assistance system, a product design generation assistance method, and a recording medium storing a product design generation assistance program.

### BACKGROUND ART

A technique of accumulating image data representing an appearance of a product including a design of the product in a database to assist search for a product whose appearance has a target feature is used in various systems.

As a technique related to such a technique, PTL 1 discloses a search assistance system including a database in which product image data is accumulated. With respect to the input image data, the system acquires, from the database, product image data of image feature information that is the same as or similar to image feature information indicating a feature of an image of the input image data. This system sets a search condition including at least one of date and time information about date and time, location information about location, and situation information about situation. Then, the system searches for the product image data based on the set search condition to output information related to another product different from the product related to the product image data together with the acquired product image data.

PTL 2 discloses a product search device that searches, identifies, and extracts an image of a product satisfying an accepted search condition from a product database. The device creates data of a product list image in which an image of a product is disposed in a space of a feature amount according to the feature amount related to each of the extracted product images. In a case where the feature amount of the pattern of the product is one-dimensional, the device arranges the images of the respective products linearly along the coordinate axis of the one-dimensional feature amount according to the magnitude of the respective feature amounts related to the respective products. Then, in a case where the feature amount is two-dimensional, the device arranges the images of the respective products in a matrix along each of the two coordinate axes constituting the feature amount according to the magnitude of the feature amounts related to the respective products.

### CITATION LIST

### Patent Literature

PTL 1: WO 2011/078174 A1
PTL 2: JP 2015-162198 A

### SUMMARY OF INVENTION

### Technical Problem

For example, in a product shelf on which various products are displayed, attracting attention of customers relative to an existing product whose design competes with that of the product may be one of factors that the product sells well. However, the product design is often manually created by a designer. Therefore, it may be difficult to create the design as described above due to restrictions on the knowledge, work man-hours, work time, and the like of the designer. PTLs 1 to 2 described above do not particularly mention such a technique.

A main object of the present invention is to provide a product design generation assistance device that solves the above-described problems.

### Solution to Problem

A product design generation assistance device according to an aspect of the present invention includes an acquisition means configured to acquire an existing product image representing a design of an existing product, an identification means configured to identify, based on the existing product image, a feature of a design of a new product, the feature satisfying a condition regarding a difference from the design of the existing product, and an output means configured to output, based on the feature related to the design of the new product, design information related to the design of the new product.

In another aspect of achieving the above object, a product design generation assistance method according to an aspect of the present invention includes an information processing system acquiring an existing product image representing a design of an existing product, identifying, based on the existing product image, a feature of a design of a new product, the feature satisfying a condition regarding a difference from the design of the existing product, and outputting, based on the feature related to the design of the new product, design information related to the design of the new product.

From a further viewpoint of achieving the above object, a product design generation assistance program according to an aspect of the present invention causes a computer to execute an acquisition step of acquiring an existing product image representing a design of an existing product, an identification step of identifying, based on the existing product image, a feature of a design of a new product, the feature satisfying a condition regarding a difference from the design of the existing product, and an output step of outputting, based on the feature related to the design of the new product, design information related to the design of the new product.

Furthermore, the present invention can also be achieved by a computer-readable nonvolatile recording medium storing the product design generation assistance program (computer program).

### Advantageous Effects of Invention

According to the present invention, it is possible to obtain a product design generation assistance device or the like that assists generation of a product design that attracts attention relative to an existing product.

### BRIEF DESCRIPTION OF DRAWINGS

FIG. 1 is a block diagram illustrating a configuration of a product design generation assistance device 10 according to the first example embodiment of the present invention.

FIG. 2 is a diagram illustrating a feature vector space in which product designs are disposed by an extraction unit 12 according to the first example embodiment of the present invention (in a case where design candidates of a new product have already been narrowed down).

FIG. 3 is a flowchart illustrating an operation (processing) of the product design generation assistance device 10 according to the first example embodiment of the present invention (in a case where design candidates of a new product have already been narrowed down).

FIG. 4 is a diagram illustrating a feature vector space in which product designs are disposed by the extraction unit 12 according to the first example embodiment of the present invention (in a case where a design candidate of a new product is not created).

FIG. 5 is a flowchart illustrating an operation (processing) of the product design generation assistance device 10 according to the first example embodiment of the present invention (in a case where a design candidate for a new product is not created).

FIG. 6 is a block diagram illustrating a configuration of a product design generation assistance system 10A according to a modification of the first example embodiment of the present invention.

FIG. 7 is a block diagram illustrating a configuration of a product design generation assistance device 30 according to the second example embodiment of the present invention.

FIG. 8 is a block diagram illustrating a configuration of an information processing device 900 capable of achieving the product design generation assistance device according to each example embodiment of the present invention.

### EXAMPLE EMBODIMENT

Hereinafter, example embodiments of the present invention will be described in detail with reference to the drawings.

### First Example Embodiment

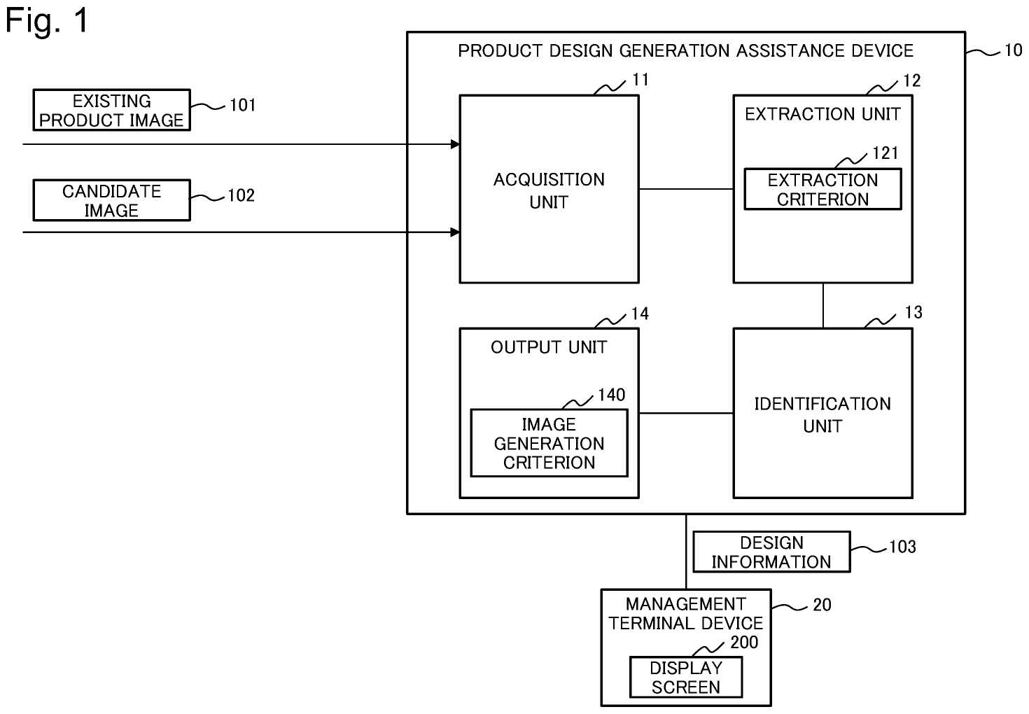

FIG. 1 is a block diagram illustrating a configuration of a product design generation assistance device 10 according to the first embodiment of the present invention. The product design generation assistance device 10 according to the present example embodiment is a system that assists generation of a product design that attracts attention of customers relative to a competing existing product (competing product) on a product shelf of a store, for example. The product design targeted by the product design generation assistance device 10 is, for example, a package design of a container such as a can or a bottle in which a product such as a beverage is put, or a box or a bag in which a product such as a food is packed. The product design targeted by the product design generation assistance device 10 may be, for example, a design of a product itself such as confectionery such as a cookie or such as an automobile. More specifically, the design of the product is, for example, the shape, pattern, color, and the like of the product, but is not limited thereto.

A management terminal device 20 is communicably connected to the product design generation assistance device 10. The management terminal device 20 is, for example, a personal computer or another information processing device used when a user using the product design generation assistance device 10 inputs information to the product design generation assistance device 10 or confirms information output from the product design generation assistance device 10. The management terminal device 20 includes a display screen 200 that displays design information 103 and the like, which will be described later, output from the product design generation assistance device 10.

The product design generation assistance device 10 includes an acquisition unit 11, an extraction unit 12, an identification unit 13, and an output unit 14. The acquisition unit 11, the extraction unit 12, the identification unit 13, and the output unit 14 are examples of an acquisition means, an extraction means, an identification means, and an output means, respectively.

Regarding the product design generation assistance device 10 assisting generation of a design of a new product, for example, there are roughly the following two cases.
(1) A case where a new product has already been narrowed down to a plurality of design candidates, and a design candidate that attracts attention of customers most relative to an existing product is selected from the plurality of design candidates.
(2) A case where a design candidate for a new product has not yet been created, and a design candidate that attracts attention of customers most relative to an existing product is to be created from now on.

Next, operations of the product design generation assistance device 10 according to the present example embodiment in the above two cases will be described in order.

<(1) when there is Already a Plurality of Design Candidates for a New Product>

The acquisition unit 11 acquires an existing product image 101 and a candidate image 102 from an external device, for example, according to an instruction input by the user.

The existing product image 101 is information indicating the designs of one or more competing existing products. More specifically, for example, the existing product image 101 is an image obtained by imaging the existing product. Note that the existing product may be, for example, a product selected by the user and sold well by a competitor.

The candidate image 102 is, for example, information representing a plurality of design candidates (design proposals) already created by a designer or the like for a new product. More specifically, for example, the candidate image 102 is an image of the design candidate.

The extraction unit 12 extracts the feature of the design represented by the existing product image 101 and the feature of the design candidate represented by the candidate image 102 based on an extraction criterion 121 given in advance by the user or the like.

For example, the features of the design image and the design candidate image are the shape of the product indicated by the design image or the design candidate image, the size of the character, the font of the character, the position of the character, the color of the character, and the color tone of the character drawn on the product, the type of the picture drawn on the product (a person, an animal, an object, a scene, a figure, and the like), the color and color tone of the picture drawn on the product, and the like, but are not limited thereto as long as the features are drawn on the product.

The extraction criterion 121 represents a criterion (rule) for the extraction unit 12 to extract the above-described feature of the design represented by the existing product image 101 and the above-described feature of the design candidate represented by the candidate image 102 using the existing image recognition technology.

The extraction criterion 121 may be, for example, an extraction rule manually created for extracting a feature.

The extraction criterion 121 may be a feature extraction model trained to extract feature amounts of images of various products. The extraction unit 12 can extract a feature amount related to each image from the existing product image 101 or the candidate image 102 by using the extraction rule or the extraction model described above.

For example, the extraction unit 12 extracts a feature amount related to a color tone of a character or a picture by using the extraction rule or the extraction model described above. The feature amount related to the color tone is expressed as, for example, a finite value such as RGB (Red Green Blue) gradation (for example, 256 gradations in the case of 8 bits).

For example, the extraction unit 12 extracts the feature amount regarding the shape of the product by using the extraction rule or the extraction model described above. The feature amount regarding the shape of the product is represented as a finite value scored in such a way that similar shapes have close values, for example, “10” in the case of a circle, “11” in the case of an ellipse, “20” in the case of a square, and “21” in the case of a rectangle.

For example, the extraction unit 12 extracts a feature related to a position (position coordinates in the image) of the character or the picture in the existing product image 101 or the candidate image 102 by using the extraction rule or the extraction model described above. In this case, the picture may be, for example, an image of an object related to a product. More specifically, for example, when the product is orange juice, the picture may be a picture of an orange. The feature amount related to the position of the character or the picture is expressed as, for example, a finite value such as the coordinate of the display position of the product.

For example, by using the extraction rule or the extraction model described above, the extraction unit 12 extracts, in the existing product image 101 or the candidate image 102, a feature related to the size of the character or the picture and the area occupied by the character or the picture. The feature amounts related to the size and the area of the character or the picture are expressed as finite values representing these values.

For example, the extraction unit 12 extracts a feature related to the font of the character by using the extraction rule or the extraction model described above. In this case, the more similar the fonts are, the closer values the feature amounts related to the fonts have. The feature amount related to the font of the character is expressed as a finite value representing the type of the font.

For example, the extraction unit 12 extracts features related to the type of picture drawn in the existing product image 101 or the candidate image 102. In this case, the more similar the types of pictures are, the closer values the feature amounts related to those types have.

The extraction unit 12 arranges each of the designs of the existing product and the design candidates of the new product in which the features are quantified as described above in the feature vector space representing the features. Note that, since the feature amount of the design is expressed as a finite value as described above, the feature vector space may be a space having a finite size (having a finite region) defined by values that can be taken by the feature amounts of respective elements.

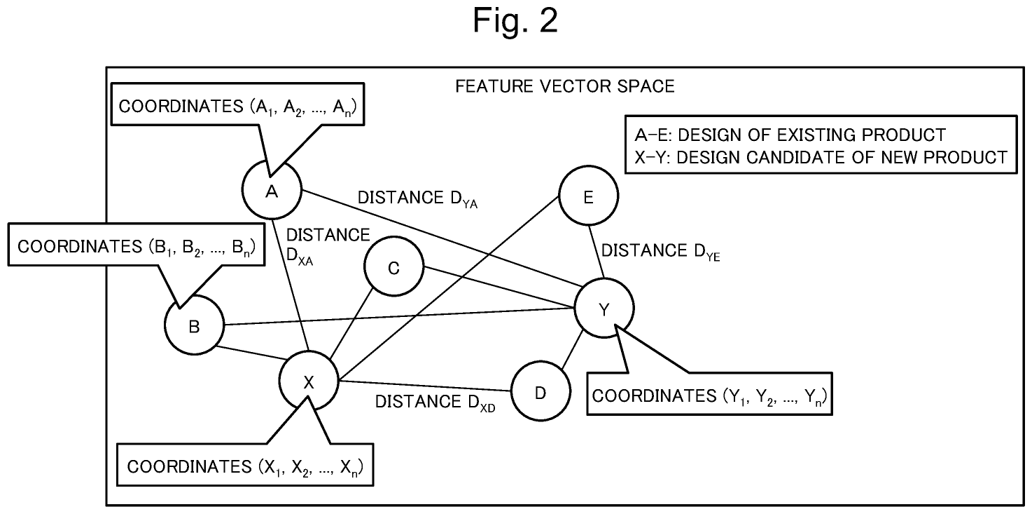

FIG. 2 is a diagram illustrating a feature vector space in which designs of the existing products and design candidates of a new product are disposed by the extraction unit 12 in a case where a new product is narrowed down to a plurality of design candidates of the new product. The feature vector space in FIG. 2 is an n-dimensional space in which features of n elements such as a position, a size, and a color tone of the character or the picture are set as dimensions.

In FIG. 2, nodes A to E represented by circles represent respective designs of the existing products, and nodes X and Y represent respective design candidates of the new product. These nodes illustrated in FIG. 2 are also referred to as feature points. In this feature vector space, for example, the coordinates of the node A are (A₁, A₂, . . . , Aₙ), and the coordinates of the node X are (X₁, X₂, . . . , Xₙ). Note that, in the feature vector space illustrated in FIG. 2, the number of nodes of the designs of the existing products is five from A to E, and the number of nodes of the design candidates of the new product is two from X and Y, but the number of nodes of the designs of the existing products and the design candidates of the new product is not limited to the above-described number and is any number.

The extraction unit 12 may also display a result of disposing designs of existing products and design candidates of a new product in the feature vector space together with coordinate axes of the feature vector space on the display screen 200 of the management terminal device 20 in, for example, a mode illustrated in FIG. 2 via the output unit 14 described later. That is, the extraction unit 12 displays the positional relationship of the nodes on the display screen 200 in such a way that the user can visually recognize the distance between the nodes in the feature vector space via the output unit 14.

Based on the existing product image 101, the identification unit 13 identifies a feature of the design of the new product, the feature satisfying the condition regarding the difference from the designs of the existing products. The difference here refers to a difference between (the features of) a plurality of existing product design images and (the features of) a new product design image. The identification unit 13 according to the present example embodiment identifies a new product design image having a difference from the existing design images larger than a predetermined criterion. In a case where there is a plurality of new product design images, the identification unit 13 according to the present example embodiment may identify a new product design image having a difference, from the existing design images, that is the largest among the plurality of new product design images.

For example, the identification unit 13 obtains a ratio of the above-described feature amount between the existing product image 101 and the candidate image 102, and identifies the candidate image 102 in which the ratio is larger than a predetermined threshold value or the ratio is the largest. More specifically, for example, the identification unit 13 obtains a ratio of a size of a character or a picture or an area occupied by the character or the picture in the image, and identifies the candidate image 102 in which the ratio is larger than a predetermined threshold value or the ratio is the largest.

Note that the identification unit 13 may use a condition regarding similarity instead of the condition regarding difference. The identification unit 13 identifies a new product design image having a similarity to the existing design image smaller than a predetermined criterion or a new product design image having the smallest similarity to the existing design image.

In the feature vector space illustrated in FIG. 2, the identification unit 13 calculates a distance of each of the nodes X and Y of the design candidates of the new product to each of the nodes A to E of the designs of the existing products. In the feature vector space illustrated in FIG. 2, for example, a line (edge) connecting the node X and the node A represents a distance between the node X and the node A, and a value thereof is D_{XA}. Similarly, for example, the distance between the node Y and the node A is D_{YA}.

For example, regarding the color tone of the design, when colors of two nodes are complementary to each other, the two nodes are in the farthest positional relationship in the feature vector space.

The identification unit 13 calculates (D_{XA}+D_{XB}+D_{XC}+D_{XD}+D_{XE}) representing the sum of the distances between the node X and the respective nodes A to E and (D_{YA}+D_{YB}+D_{YC}+D_{YD}+D_{YE}) representing the sum of the distances between the node Y and the respective nodes A to E. “+” is an operator indicating addition. Then, the identification unit 13 compares the sum of the distances between the node X and the respective nodes A to E with the sum of the distances between the node Y and the respective nodes A to E, and identifies a node having a larger sum of the distances to the nodes A to E among the nodes X and Y.

When calculating the sum of the distances between the node X or Y and the respective nodes A to E, the identification unit 13 may weight the distance according to the importance of each existing product in the competitive relationship with the new product. That is, in this case, the identification unit 13 calculates (axD_{XA}+bxD_{XB}+cxD_{XC}+dxD_{XD}+exD_{XE}) for the node X, and calculates (axD_{YA}+bxD_{YB}+cxD_{YC}+dxD_{YD}+exD_{YE}) for the node Y. “x” is an operator indicating multiplication. Furthermore, the coefficients a to e are coefficients for weighting the distance. For example, in a case where the existing product indicated by the node A is highly important in the competitive relationship with the new product (that is, in a case where the competitiveness with the existing product indicated by the node A is intense), the identification unit 13 gives a large value to the coefficient a by the user or the like. Alternatively, for example, in a case where the existing product indicated by the node B is less important in the competitive relationship with the new product (that is, the competitiveness with the existing product indicated by the node B is not intense), the identification unit 13 gives a small value to the coefficient b by the user or the like.

In a case where the number of nodes of the design candidates of the new product is large, the identification unit 13 may identify a plurality of nodes in which the sum of the distances to the respective nodes of the design of the existing products satisfies the condition among the nodes. More specifically, for example, the identification unit 13 may sequentially identify nodes having up to a predetermined rank from the node having the largest sum of distances to respective nodes of the designs of the existing products among the nodes of the design candidates of the new product.

The output unit 14 outputs the design information 103 representing the node X or the node Y identified by the identification unit 13 to the management terminal device 20. The output unit 14 may output, as the design information 103, an identifier capable of identifying the node X or the node Y, or may output the candidate image 102 of the node X or the node Y. The management terminal device 20 displays the design information 103 output from the output unit 14 on the display screen 200.

As described above, under the control of the extraction unit 12, the output unit 14 may output, to the management terminal device 20, information for displaying the result of disposing the designs of the existing products and the design candidates of the new product in the feature vector space together with the coordinate axes of the feature vector space on the display screen 200 in the mode illustrated in FIG. 2, for example. At this time, the management terminal device 20 may display an image representing the design related to the selected node on the display screen 200 according to an operation by the user selecting a node indicating the feature of the design of the existing product or the feature of the design of the new product in the feature vector space. That is, for example, when the user performs an input operation to select the node A displayed on the display screen 200, the management terminal device 20 displays the existing product image 101 of the existing product indicated by the node A on the display screen 200.

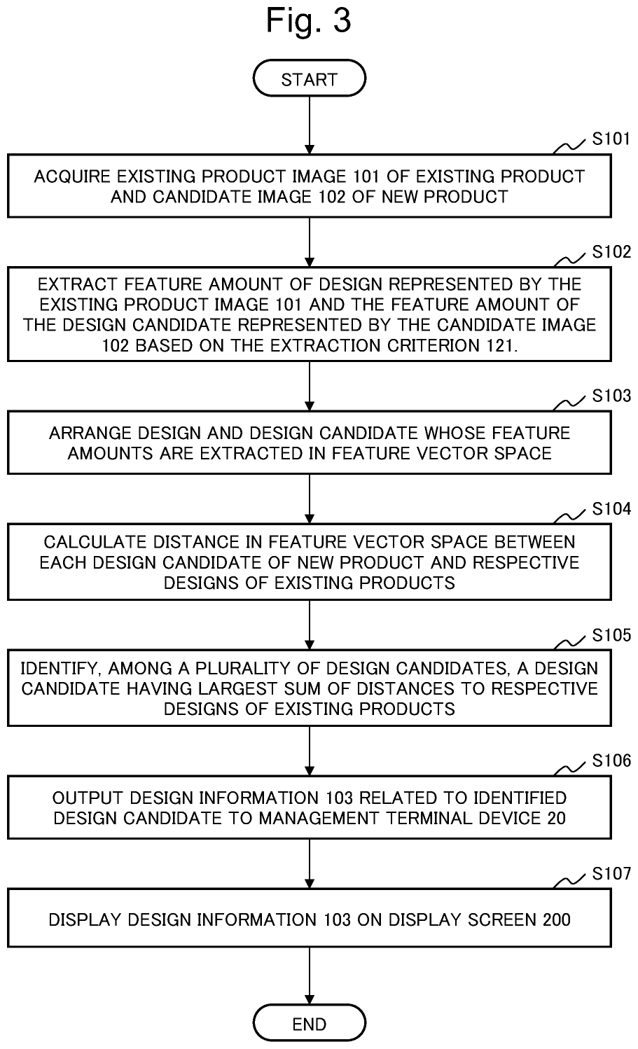

Next, the operation (processing) of the product design generation assistance device 10 according to the present example embodiment in a case where there are design candidates of a new product will be described in detail with reference to the flowchart of FIG. 3.

The acquisition unit 11 acquires the existing product image 101 representing a design of an existing product and a candidate image 102 representing a design candidate of a new product (step S101). The extraction unit 12 extracts the feature amount of the design represented by the existing product image 101 and the feature amount of the design candidate represented by the candidate image 102 based on the extraction criterion 121 (step S102).

The extraction unit 12 arranges the design of the existing product and the design candidate of the new product, whose feature amounts have been extracted, in the feature vector space (step S103).

The identification unit 13 calculates a distance in the feature vector space between each design candidate of the new product and respective designs of the existing products (step S104). The identification unit 13 identifies a design candidate having the largest sum of distances to respective designs of the existing products among a plurality of design candidates of the new product (step S105). The output unit 14 outputs, to the management terminal device 20, the design information 103 related to the design candidate of the new product identified by the identification unit 13 (step S106). The management terminal device 20 displays the design information 103 on the display screen 200 (step S107), and the entire processing ends.

<(2) when there is No Design Candidate for New Product>

The acquisition unit 11 acquires the existing product image 101 from an external device, for example, according to an instruction input by the user. In this case, unlike the case of (1) described above, there is no candidate image 102.

As in the case of (1) described above, the extraction unit 12 extracts the feature amount of the design represented by the existing product image 101 based on the extraction criterion 121.

The extraction unit 12 arranges the design of the existing product whose feature amount has been extracted in the feature vector space.

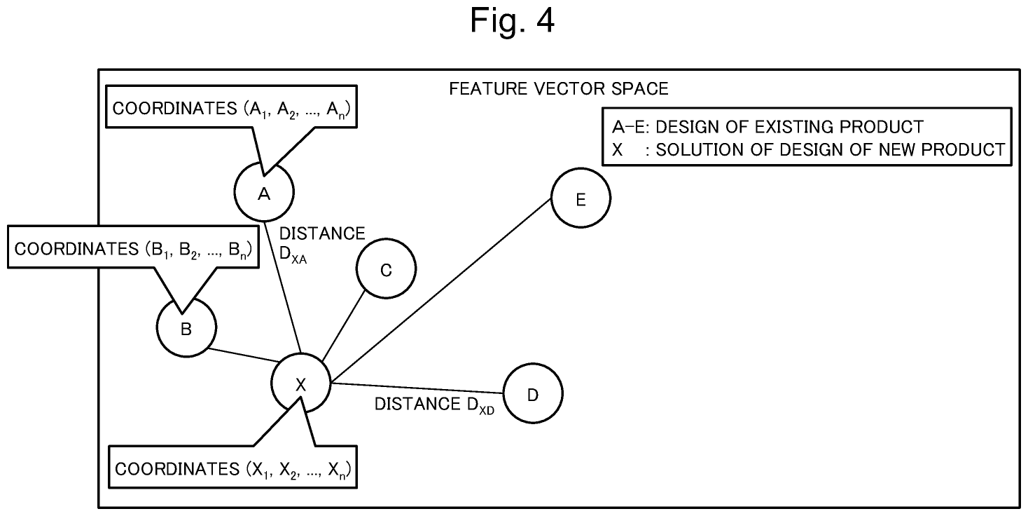

FIG. 4 is a diagram illustrating a feature vector space in which respective designs of existing products are disposed by the extraction unit 12 in a case where a design candidate of a new product has not yet been created. As in the feature vector space illustrated in FIG. 2, the feature vector space illustrated in FIG. 4 is an n-dimensional space having dimensions of features of n elements such as a position, a size, and a color tone of the character or the picture.

The extraction unit 12 arranges, at any position in the feature vector space, a node X representing a solution of a design of a new product that attracts attention of customers relative to an existing product.

The identification unit 13 calculates the distance between the node X and the respective nodes A to E of the designs of the existing products while changing the position of the node X in the feature vector space illustrated in FIG. 4. The calculation procedure of the distance by the identification unit 13 is as described above in the case of (1).

The identification unit 13 searches and identifies the position of the node X in the feature vector space having a finite width (region) in such a way that the sum of the distances between the node X and the respective nodes A to E is the largest. Alternatively, the identification unit 13 may identify a region where the node X is located in which the sum of the distances between the node X and the respective nodes A to E is, for example, equal to or more than a threshold value.

The identification unit 13 may also exclude a predetermined region in the feature vector space from the search target when identifying the position of the node X whose distance to the respective nodes A to E satisfies the criterion. The area excluded from the search target is, for example, an area representing a feature of a design that gives an unfavorable impression to the customer. More specifically, the excluded region is, for example, a region representing a color tone or the like that gives an impression that a product is not delicious when the product is a food. Note that the features of the design that gives an unfavorable impression to the customer are obtained as results of previous investigations and research on the impression that the product design gives to the customer. Then, it is assumed that the identification unit 13 is given the excluded area by, for example, a user or the like. By being given an example of a product image that gives an unfavorable impression to the customer as the existing product image 101, the identification unit 13 may also search for a region away from the region representing a feature of the product image in the feature vector space.

The output unit 14 displays the design information 103 indicating the feature of the package design indicated by the position of the node X identified by the identification unit 13 on the display screen 200 of the management terminal device 20. The design information 103 is, for example, information including at least one of a logo, a color tone, a size of a character, a position of a character, and a font of a character related to a design of a new product.

The output unit 14 may further generate an image representing the design based on a value (feature amount) representing the feature of the design indicated by the position of the identified node X and an image generation criterion 140 given in advance. The image generation criterion 140 may include conditions for generating an image. The image generation criterion 140 may include, for example, a condition regarding at least one of a color to be used, a display position and a size of a character or a picture as a condition for generating an image.

The image generation method is not limited to the rule-based method as described above. For example, the image generation criterion 140 may be an image generation model (trained model) that is trained on a relationship between a feature amount representing a feature of a design of an existing product disposed in a feature vector space and an actual image of the design of the existing product. The image generation model may be generated by, for example, being trained to reduce, based on a generated image generated from a feature amount represented by coordinates in a feature vector space of an image of an existing product and an actual image of the existing product, a difference (distance in the feature vector space) between the generated image and the actual image of the existing product. The method of generating the image generation model is not limited to the above method.

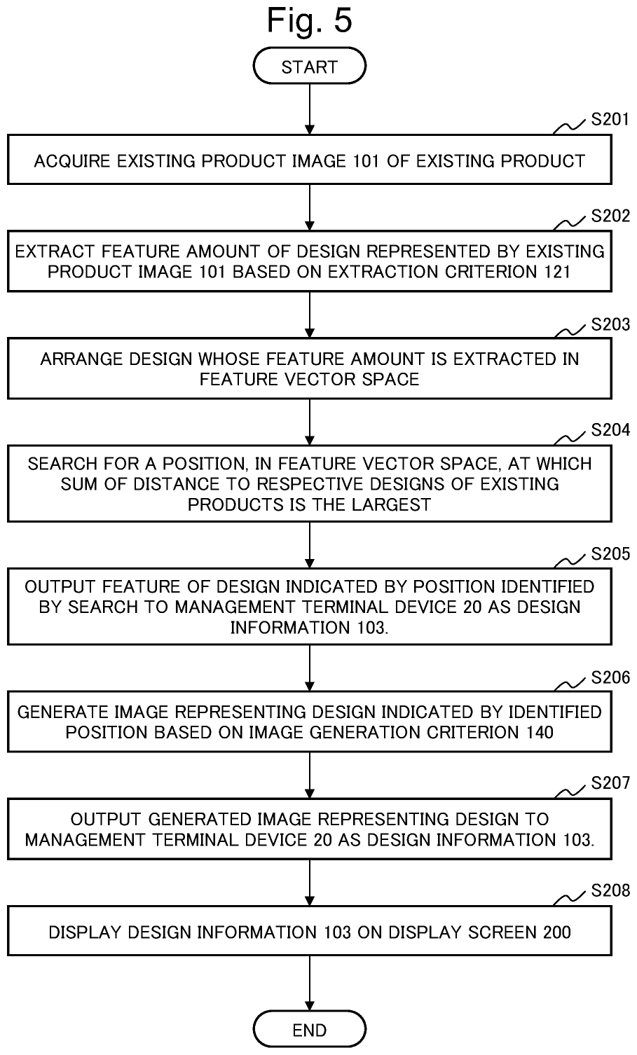

Next, the operation (processing) of the product design generation assistance device 10 according to the present example embodiment in a case where there is no design candidate for a new product will be described in detail with reference to a flowchart of FIG. 5.

The acquisition unit 11 acquires the existing product image 101 representing the design of the existing product (step S201). The extraction unit 12 extracts the feature amount of the design represented by the existing product image 101 based on the extraction criterion 121 (step S202).

The extraction unit 12 arranges the design of the existing product whose feature amount has been extracted in the feature vector space (step S203).

The identification unit 13 searches for a position, in the feature vector space, at which the sum of the distances to the respective designs of the existing products is the largest (step S204). The identification unit 13 outputs the feature of the design indicated by the position identified by searching the feature vector space to the management terminal device 20 as the design information 103 (step S205).

The output unit 14 generates an image representing the design indicated by the position identified by the identification unit 13 based on the image generation criterion 140 (step S206). The output unit 14 outputs the generated image representing the design to the management terminal device 20 as the design information 103 (step S207). The management terminal device 20 displays the design information 103 on the display screen 200 (step S208), and the entire process ends.

The product design generation assistance device 10 according to the present example embodiment can assist generation of a product design that attracts attention relative to an existing product. The reason is that the product design generation assistance device 10 identifies a feature of the design of the new product, the feature satisfying a condition regarding a difference from a design of the existing product, to output design information about the design of the new product based on the identified feature.

Hereinafter, effects achieved by the product design generation assistance device 10 according to the present example embodiment will be described in detail.

For example, in a product shelf on which various products are displayed, attracting attention of customers relative to an existing product whose design competes with that of the product may be one of factors that the product sells well. However, the product design is often manually created by a designer. Therefore, it may be difficult to create the design as described above due to restrictions on the knowledge, work man-hours, work time, and the like of the designer.

In order to solve such a problem, the product design generation assistance device 10 according to the present example embodiment includes the acquisition unit 11, the identification unit 13, and the output unit 14, and operates as described above with reference to FIGS. 1 to 5, for example. That is, the acquisition unit 11 acquires the existing product image 101 representing the design of the existing product. Based on the existing product image 101, the identification unit 13 identifies a feature of the design of the new product, the feature satisfying the condition regarding the difference from the designs of the existing products. Then, the output unit 14 outputs the design information 103 related to the design of the new product based on the identified feature related to the design of the new product.

That is, since the product design generation assistance device 10 according to the present example embodiment identifies the feature of the design of the new product having a large difference (small similarity) from the design of the existing product, it is possible to assist generation of the design of the product attracting attention relative to the existing product.

The product design generation assistance device 10 according to the present example embodiment uses, as the image generation criterion 140, an image generation model generated by being trained on the relationship between the feature amount related to the design of the existing product and the image of the design of the existing product. As a result, the product design generation assistance device 10 can gradually increase the accuracy of generating the image of the design of the product that attracts attention relative to the existing product.

The product design generation assistance device 10 according to the present example embodiment extracts a feature amount related to the extracted design of the existing product, and arranges the feature amount of the design of the existing product in a feature vector space representing the feature of the design. Then, the product design generation assistance device 10 outputs an image representing a feature vector space in which the feature related to the design of the existing product and the feature related to the design of a new product are disposed. The image is displayed on, for example, the display screen 200 of the management terminal device 20 operated by the user. In response to an operation by the user selecting a feature point (node) indicating a feature related to the design of the existing product or a feature related to the design of the new product in the feature vector space, the product design generation assistance device 10 further displays an image representing the design related to the selected feature point on the display screen 200. The product design generation assistance device 10 has such a function related to the user interface, so that it is possible to improve the convenience of the user in the work of creating a product design that attracts attention relative to an existing product.

The product design generation assistance device 10 according to the present example embodiment excludes a predetermined region in the feature vector space (a region representing a feature of a design that gives an unfavorable impression to a customer) from a search target when identifying a position at which a distance to a design of an existing product satisfies a criterion. As a result, the product design generation assistance device 10 can efficiently search for the position in the feature vector space where the distance to the design of the existing product satisfies the criterion.

The product design generation assistance device 10 according to the present example embodiment weights the distance to the design of the existing product according to the importance of the existing product in the competitive relationship with the new product. As a result, the product design generation assistance device 10 can assist the generation of a more strategic product design in consideration of the market environment of the new product and the like.

In a case where a new product belongs to a certain brand line, it is necessary to generate a design of the new product that satisfies both of increasing the difference from the above-described competing product and following the directionality of the brand line. In such a case, the identification unit 13 identifies the feature of the design of the new product that satisfies that the difference from the design of the first existing product in a competitive relationship with the new product is equal to or more than the criterion, and the difference from the design of the second existing product belonging to the same brand line as the new product is equal to or less than the criterion.

More specifically, for example, the acquisition unit 11 acquires an existing product image 101 representing the designs of a competing product (first existing product) and a product (second existing product) having the same brand line. The extraction unit 12 represents the design of the competing product as the nodes A to E in the feature vector space illustrated in FIG. 2 or 4. The extraction unit 12 also represents a product design of the same brand line as a node Z (not illustrated in FIGS. 2 and 4) in the feature vector space. Then, the identification unit 13 identifies the position of the node X representing the new product in such a way that the distances to the respective nodes A to E are equal to or more than the first threshold value and the distance to the node Z is equal to or less than the second threshold value in the feature vector space.

Alternatively, for example, the identification unit 13 may be given a brand guideline indicating a feature of the design of the brand line. The brand guideline is given, for example, as a predetermined region in the feature vector space. Then, the identification unit 13 identifies the position of the node X in such a way as to satisfy the constraint condition based on the brand line. For example, the identification unit 13 identifies the position of the node X at which the distances to the respective nodes A to E are equal to or more than a threshold value in a predetermined region in the feature vector space indicated by the brand guideline.

The function implemented by the product design generation assistance device 10 according to the present example embodiment described above may be implemented by a system including a plurality of information processing devices.

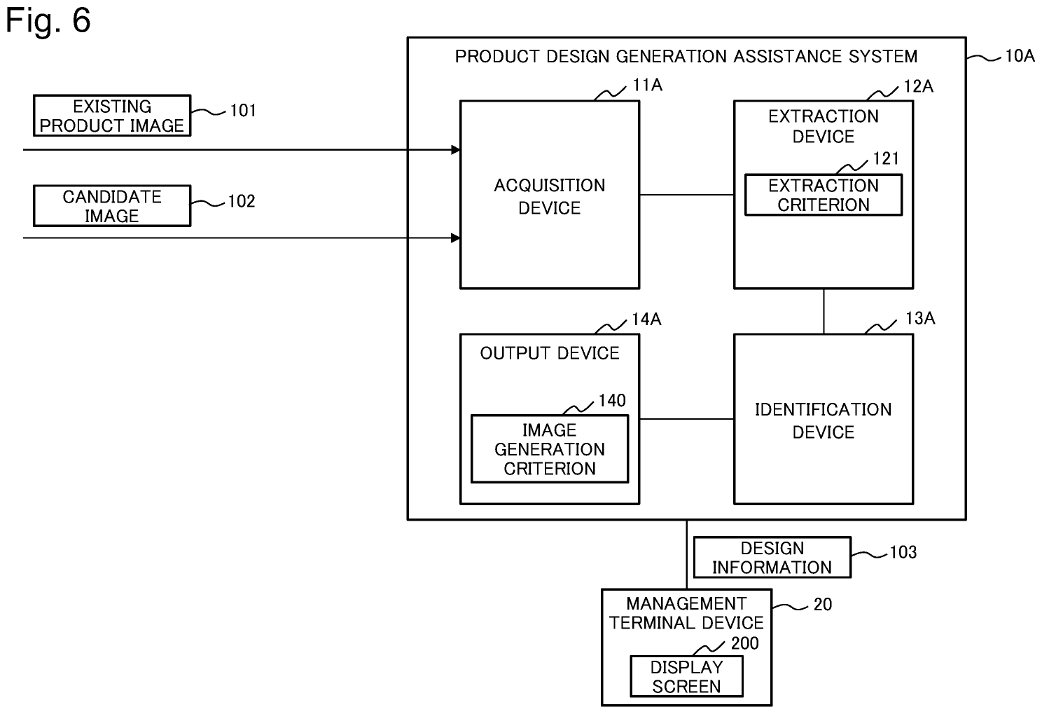

FIG. 6 is a block diagram illustrating a configuration of a product design generation assistance system 10A according to a modification of the present example embodiment. The function of the product design generation assistance system 10A is equivalent to that of the product design generation assistance device 10 described above. The product design generation assistance system 10A includes an acquisition device 11A, an extraction device 12A, an identification device 13A, and an output device 14A, each of which is an information processing device. The acquisition device 11A, the extraction device 12A, the identification device 13A, and the output device 14A have functions equivalent to those of the acquisition unit 11, the extraction unit 12, the identification unit 13, and the output unit 14 described above, respectively. The acquisition device 11A, the extraction device 12A, the identification device 13A, and the output device 14A are communicably connected to each other.

The configuration of the product design generation assistance system 10A is not limited to the configuration including the information processing device corresponding to each component of the product design generation assistance device 10. The product design generation assistance system 10A may include, for example, a plurality of components of the product design generation assistance device 10 as one information processing device.

### Second Example Embodiment

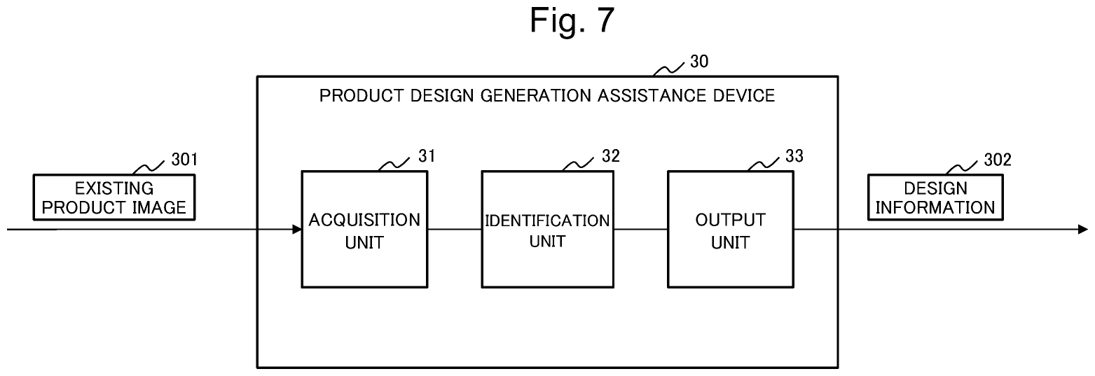

FIG. 7 is a block diagram illustrating a configuration of a product design generation assistance device 30 according to the second example embodiment of the present invention. The product design generation assistance device 30 includes an acquisition unit 31, an identification unit 32, and an output unit 33. However, the acquisition unit 31, the identification unit 32, and the output unit 33 are examples of an acquisition means, an identification means, and an output means, respectively.

The acquisition unit 31 acquires an existing product image 301 representing a design of an existing product. The existing product image 301 is, for example, an image similar to the existing product image 101 according to the first example embodiment. The acquisition unit 31 operates as in the acquisition unit 11 according to the first example embodiment, for example.

Based on the existing product image 301, the identification unit 32 identifies a feature of the design of the new product, the feature satisfying the condition regarding the difference from the design of the existing product. For example, the identification unit 32 performs processing using the same feature vector space as in the extraction unit 12 and the identification unit 13 according to the first example embodiment on the existing product image 301.

The output unit 33 outputs design information 302 related to the design of the new product based on the feature related to the design of the new product identified by the identification unit 32. The design information 302 is, for example, information similar to the design information 103 according to the first example embodiment. The output unit 33 operates as in the output unit 14 according to the first example embodiment, for example.

The product design generation assistance device 30 according to the present example embodiment can assist generation of a product design that attracts attention relative to an existing product. The reason is that the product design generation assistance device 30 identifies a feature of the design of the new product, the feature satisfying a condition regarding a difference from a design of the existing product, to output design information about the design of the new product based on the identified feature.

### <Hardware Configuration Example>

Each unit in the product design generation assistance device 10 illustrated in FIG. 1 or the product design generation assistance device 30 illustrated in FIG. 7 in each of the above-described example embodiments can be achieved by dedicated hardware (HW) (electronic circuit). In FIGS. 1 and 7, at least the following configurations can be regarded as a function (processing) unit (software module) of a software program.
Acquisition units 11 and 31
Extraction unit 12
Identification units 13 and 32
Output units 14 and 33

The division of each unit illustrated in these drawings is a configuration for convenience of description, and various configurations can be assumed at the time of implementation. An example of a hardware environment in this case will be described with reference to FIG. 7.

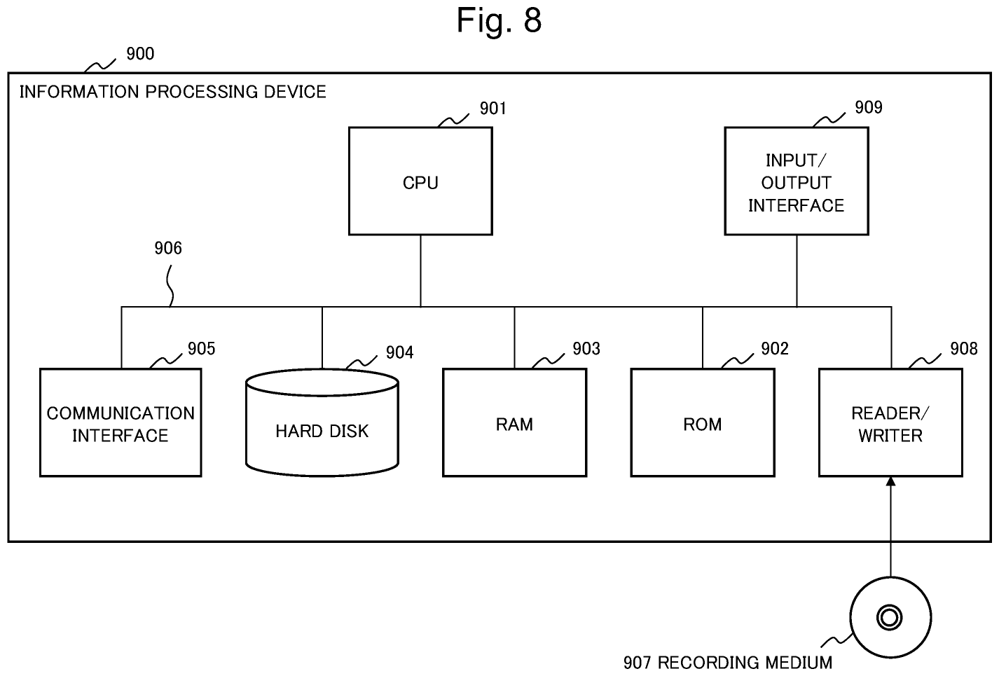

FIG. 8 is a diagram exemplarily illustrating a configuration of an information processing device 900 (computer system) capable of achieving the product design generation assistance device 10 according to the first example embodiment of the present invention or the product design generation assistance device 30 according to the second example embodiment. That is, FIG. 8 is a configuration of at least one computer (information processing device) capable of achieving the product design generation assistance devices 10 and 30 illustrated in FIGS. 1 and 7, and represents a hardware environment capable of implementing each function in the above-described example embodiment.

The information processing device 900 illustrated in FIG. 8 includes the following components as components, but may not include some of the following components.
CPU (Central_Processing_Unit) 901.
ROM (Read_Only_Memory) 902.
RAM (Random_Access_Memory) 903
Hard disk (storage device) 904
Communication interface 905 with an external device
Bus 906 (communication line)
Reader/writer 908 capable of reading and writing data stored in a recording medium 907 such as a CD-ROM (Compact_Disc_Read_Only_Memory)
Input/output interface 909 such as a monitor, a speaker, and a keyboard

That is, the information processing device 900 including the above-described components is a general computer to which these components are connected via the bus 906. The information processing device 900 may include a plurality of CPUs 901 or may include a CPU 901 configured by a plurality of cores. The information processing device 900 may include a graphical_processing_unit (GPU) (not illustrated) in addition to the CPU 901.

Then, the present invention described using the above-described example embodiment as an example supplies a computer program capable of achieving the following functions to the information processing device 900 illustrated in FIG. 8. The function is the above-described configuration in the block configuration diagram (FIGS. 1 and 7) referred to in the description of the example embodiment or the function of the flowchart (FIGS. 3 and 5). Thereafter, the present invention is achieved by reading, interpreting, and executing the computer program on the CPU 901 of the hardware. The computer program supplied into the device may be stored in a readable/writable volatile memory (RAM 903) or a non-volatile storage device such as the ROM 902 or the hard disk 904.

In the above case, a general procedure can be used at present as a method of supplying the computer program into the hardware. Examples of the procedure include a method of installing the program in the device via various recording media 907 such as a CD-ROM, a method of downloading the program from the outside via a communication line such as the Internet, and the like. In such a case, the present invention can be understood to be configured by a code constituting the computer program or the recording medium 907 storing the code.

The present invention is described above using the above-described example embodiments as exemplary examples. However, the present invention is not limited to the above-described example embodiments. That is, it will be understood by those of ordinary skill in the art that the present invention can have various aspects without departing from the spirit and scope of the present invention as defined by the claims.

Note that part or all of each example embodiment described above can also be described as the following Supplementary Notes. However, the present invention exemplarily described by the above-described example embodiments is not limited to the following.

### Supplementary Note 1

A product design generation assistance device including
an acquisition means configured to acquire an existing product image representing a design of an existing product,
an identification means configured to identify, based on the existing product image, a feature of a design of a new product, the feature satisfying a condition regarding a difference from the design of the existing product, and
an output means configured to output, based on the feature related to the design of the new product, design information related to the design of the new product.

### Supplementary Note 2

The product design generation assistance device according to Supplementary Note 1, wherein
the design information includes at least one of a logo, a color, a color tone, a shape, a size of a character, a position of a character, and a font of a character related to the design of the new product, an image of an object related to the new product, and a position of the image.

### Supplementary Note 3

The product design generation assistance device according to Supplementary Note 1 or 2, wherein
the output means outputs an image representing the design of the new product based on an image generation criterion.

### Supplementary Note 4

The product design generation assistance device according to Supplementary Note 3, wherein
the image generation criterion is an image generation model generated by being trained on a relationship between a feature amount related to the design of the existing product and the image of the design of the existing product.

### Supplementary Note 5

The product design generation assistance device according to Supplementary Note 3 or 4, wherein
the image generation criterion includes a condition related to at least one of a color, or a display position or a size of a character or a picture to be used in the design of the new product.

### Supplementary Note 6

The product design generation assistance device according to any one of Supplementary Notes 1 to 5, further including
an extraction means configured to extract a feature related to the design of the existing product based on the existing product image, wherein
the identification means identifies the feature related to the design of the new product based on the feature related to the design of the existing product.

### Supplementary Note 7

The product design generation assistance device according to Supplementary Note 6, wherein
the acquisition means acquires a plurality of candidate images related to a plurality of design candidates of the new product, wherein
the extraction means extracts features related to the plurality of design candidates of the new product based on the plurality of candidate images, wherein
the identification means identifies a specific design from the plurality of design candidates of the new product based on the feature related to the design of the existing product and features related to the plurality of design candidates of the new product, and wherein
the output means outputs design information related to the specific design.

### Supplementary Note 8

The product design generation assistance device according to Supplementary Note 6 or 7, wherein
the extraction means digitizes the extracted feature related to the design of the existing product to arrange the design of the existing product in a feature vector space representing the feature of the design, wherein
the identification means identifies a position at which a distance to the design of the existing product satisfies a condition in the feature vector space, and wherein
the output means outputs design information related to the design of the new product, the design information being indicated by the position identified by the identification means.

### Supplementary Note 9

The product design generation assistance device according to Supplementary Note 8, wherein
the output means outputs an image representing the feature vector space including the feature related to the design of the existing product and the feature related to the design of the new product.

### Supplementary Note 10

The product design generation assistance device according to Supplementary Note 9, wherein
the output means outputs, according to an operation of selecting a feature point indicating the feature related to the design of the existing product or the feature related to the design of the new product in the feature vector space, an image representing a design related to the selected feature point.

### Supplementary Note 11

The product design generation assistance device according to any one of Supplementary Notes 8 to 10, wherein
the identification means excludes a predetermined region in the feature vector space from a search target at a time of identifying the position at which the distance to the design of the existing product satisfies a criterion.

### Supplementary Note 12

The product design generation assistance device according to any one of Supplementary Notes 8 to 11, wherein
the identification means performs weighting on the distance to the design of the existing product according to importance of the existing product in a competitive relationship with the new product.

### Supplementary Note 13

The product design generation assistance device according to any one of Supplementary Notes 1 to 12, wherein
in the feature of the design of the new product, a difference from a feature of a design of a first existing product that is in a competitive relationship with the new product satisfies a first condition (equal to or more than a criterion), and a difference from a feature of a design of a second existing product belonging to a brand line same as a brand line of the new product satisfies a second condition (equal to or less than a criterion).

### Supplementary Note 14

The product design generation assistance device according to Supplementary Note 13, wherein
the acquisition means acquires the existing product images representing the designs of the first and second existing products, and wherein
the identification means identifies the feature of the design of the new product based on the existing product images of the first and second existing products.

### Supplementary Note 15

The product design generation assistance device according to Supplementary Note 13, wherein
the identification means identifies the feature of the design of the new product in such a way as to satisfy a constraint condition based on the feature of the second existing product.

### Supplementary Note 16

A product design generation assistance system including
an acquisition means configured to acquire an existing product image representing a design of an existing product,
an identification means configured to identify, based on the existing product image, a feature of a design of a new product, the feature satisfying a condition regarding a difference from the design of the existing product, and
an output means configured to output, based on the feature related to the design of the new product, design information related to the design of the new product.

### Supplementary Note 17

A product design generation assistance method including
an information processing system
acquiring an existing product image representing a design of an existing product,
identifying, based on the existing product image, a feature of a design of a new product, the feature satisfying a condition regarding a difference from the design of the existing product, and
outputting, based on the feature related to the design of the new product, design information related to the design of the new product.

### Supplementary Note 18

A recording medium storing a product design generation assistance program for causing a computer to execute
an acquisition step of acquiring an existing product image representing a design of an existing product,
an identification step of identifying, based on the existing product image, a feature of a design of a new product, the feature satisfying a condition regarding a difference from the design of the existing product, and
an output step of outputting, based on the feature related to the design of the new product, design information related to the design of the new product.

### REFERENCE SIGNS LIST

10 product design generation assistance device
10A product design generation assistance system
101 existing product image
102 candidate image
103 design information
11 acquisition unit
11A acquisition device
12 extraction unit
12A extraction device
121 extraction criterion
13 identification unit
13A identification device
14 output unit
14A output device
140 image generation criterion
20 management terminal device
200 display screen
30 product design generation assistance device
301 existing product image
302 design information
31 acquisition unit
32 identification unit
33 output unit
900 information processing device
901 CPU
902 ROM
903 RAM
904 hard disk (storage device)
905 communication interface
906 bus
907 recording medium
908 reader/writer
909 input/output interface

What is claimed is:

1. A product design generation assistance device comprising:
at least one memory storing a computer program; and
at least one processor configured to execute the computer program to
acquire an existing product image representing a design of an existing product;
identify, based on the existing product image, a feature of a design of a new product, the feature satisfying a condition regarding a difference from the design of the existing product; and
output, based on the feature related to the design of the new product, design information related to the design of the new product.

2. The product design generation assistance device according to claim 1, wherein
the design information includes at least one of a logo, a color, a color tone, a shape, a size of a character, a position of a character, and a font of a character related to the design of the new product, an image of an object related to the new product, and a position of the image.

3. The product design generation assistance device according to claim 1, wherein the processor is configured to execute the computer program to
output an image representing the design of the new product based on an image generation criterion.

4. The product design generation assistance device according to claim 3, wherein
the image generation criterion is an image generation model generated by being trained on a relationship between a feature amount related to the design of the existing product and the image of the design of the existing product.

5. The product design generation assistance device according to claim 3, wherein
the image generation criterion includes a condition related to at least one of a color, or a display position or a size of a character or a picture to be used in the design of the new product.

6. The product design generation assistance device according to claim 1, wherein the processor is configured to execute the computer program to
to extract a feature related to the design of the existing product based on the existing product image, and
identify the feature related to the design of the new product based on the feature related to the design of the existing product.

7. The product design generation assistance device according to claim 6, wherein the processor is configured to execute the computer program to
acquire a plurality of candidate images related to a plurality of design candidates of the new product,
extract features related to the plurality of design candidates of the new product based on the plurality of candidate images,
identify a specific design from the plurality of design candidates of the new product based on the feature related to the design of the existing product and features related to the plurality of design candidates of the new product, and
output design information related to the specific design.

8. The product design generation assistance device according to claim 6, wherein the processor is configured to execute the computer program to
digitize the extracted feature related to the design of the existing product to arrange the design of the existing product in a feature vector space representing the feature of the design,
identify a position at which a distance to the design of the existing product satisfies a condition in the feature vector space, and
output design information related to the design of the new product, the design information being indicated by the identified position.

9. The product design generation assistance device according to claim 8, wherein the processor is configured to execute the computer program to
output an image representing the feature vector space including the feature related to the design of the existing product and the feature related to the design of the new product.

10. The product design generation assistance device according to claim 9, wherein the processor is configured to execute the computer program to
output, according to an operation of selecting a feature point indicating the feature related to the design of the existing product or the feature related to the design of the new product in the feature vector space, an image representing a design related to the selected feature point.

11. The product design generation assistance device according to claim 8, wherein the processor is configured to execute the computer program to
exclude a predetermined region in the feature vector space from a search target at a time of identifying the position at which the distance to the design of the existing product satisfies a criterion.

12. The product design generation assistance device according to claim 8, wherein the processor is configured to execute the computer program to
perform weighting on the distance to the design of the existing product according to importance of the existing product in a competitive relationship with the new product.

13. The product design generation assistance device according to claim 1, wherein
in the feature of the design of the new product, a difference from a feature of a design of a first existing product that is in a competitive relationship with the new product satisfies a first condition (equal to or more than a criterion), and a difference from a feature of a design of a second existing product belonging to a brand line same as a brand line of the new product satisfies a second condition (equal to or less than a criterion).

14. The product design generation assistance device according to claim 13, wherein the processor is configured to execute the computer program to
acquire the existing product images representing the designs of the first and second existing products, and
identify the feature of the design of the new product based on the existing product images of the first and second existing products.

15. The product design generation assistance device according to claim 13, wherein the processor is configured to execute the computer program to
identify the feature of the design of the new product in such a way as to satisfy a constraint condition based on the feature of the second existing product.

16. (canceled)

17. A product design generation assistance method comprising:
an information processing system acquiring an existing product image representing a design of an existing product;
identifying, based on the existing product image, a feature of a design of a new product, the feature satisfying a condition regarding a difference from the design of the existing product; and
outputting, based on the feature related to the design of the new product, design information related to the design of the new product.

18. A non-transitory computer-readable recording medium storing a product design generation assistance program for causing a computer to execute:
an acquisition step of acquiring an existing product image representing a design of an existing product;
an identification step of identifying, based on the existing product image, a feature of a design of a new product, the feature satisfying a condition regarding a difference from the design of the existing product; and
an output step of outputting, based on the feature related to the design of the new product, design information related to the design of the new product.
